(19) United States
(12) Patent Application Publication
(10) Pub. No.: US 2005/0073976 A1
(43) Pub. Date: Apr. 7, 2005

(54) System and method for transmitting common data in a mobile communication system

(75) Inventor: Masaaki Fujii, Yokohama (JP)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/957,347

(22) Filed: Oct. 1, 2004

(30) Foreign Application Priority Data
Oct. 1, 2003 (JP) 343612/2003

(51) Int. Cl. H04Q 7/00

(52) U.S. Cl. 370/334

(57) ABSTRACT

A common channel transmission system and method for transmitting common data to multiple users by means of a multibeam. A common data coding means space-time codes the common data throughout all beams included in the multibeam. A data transmission means assigns the common data space-time coded by the common data coding means to all beams included in the multibeam and transmits the common data to the multiple users.

### PRIORITY

This application claims priority to an application entitled “System and Method for Transmitting Common Data in Mobile Communication System” filed in the Japanese Patent Office on Oct. 1, 2003 and assigned Serial No. 2003-343612, the contents of which are hereby incorporated by reference.

### BACKGROUND OF THE INVENTION

1. Field of the Invention

The present invention relates generally to a transmission antenna array and a space-time transmission diversity used in a communication system, and more particularly to a common channel transmission system and method for transmitting common data to multiple users by means of a multibeam.

2. Description of the Related Art

Commonly, a downlink common control channel transmission method using a multibeam antenna transmission is used to transmit over a common control channel in a base station (BS) using an adaptive antenna array transmission diversity of a downlink in a wideband code division multiple access (W-CDMA) mobile communication system.

According to the conventional arts, the common control channel is used with an array antenna for an individual channel. Therefore, a sector antenna for the common control channel and an RF transmission circuit are unnecessary, and the common control channel is distributed in the array antenna. Accordingly, when compared with the existing sector antenna transmission method, this method can reduce maximum transmission power for each antenna.

Further, according to an article entitled “Minimal Non-Orthogonality Rate 1 Space-Time Block Code for 3+Tx Antennas (proc. ISSSTA'00, New Jersey, pp. 429-432)” published on September, 2000 by O. Trikkonen, A. Boariu, and A. Hottinen, a construction method of a coding matrix for minimally suppressing an effect of non-orthogonality occurring in extending a space-time coding matrix has been described. According to the article, interference occurring by non-orthogonality in data transmission in a communication system is minimally suppressed, thereby maximizing decoding efficiency.

Additionally, a number of patent applications have been filed for schemes that enable one or two beams to be selected from a plurality of transmission beams according to direction of each user in a mobile communication system.

For example, in an orthogonal frequency division multiplexing-code division multiplexing (OFDM-CDM), which is a method for performing time-direction spreading or two-dimensional spreading, there are patents regarding a time beam space transmit diversity scheme in which two beams in a user direction are selected from fixed multibeams and space-time coding is applied to space of the two selected beams. Alternatively, an inter-code beam space transmit diversity scheme is known in the art in which a time direction output of a space-time code is code-division-multiplexed in the same spreading area and the multiplexed output is applied to space of two beams

According to the conventional arts as described above, because one or two beams are selected from a plurality of beams according to a direction of each user, different users use different beams or beam pairs. Accordingly, there is a problem in that data (e.g., common control information, broadcasting, etc) cannot be transmitted to all users at a high rate of efficiency.

More specifically, when the common information is transmitted to each user, because redundant information corresponding to each user must be transmitted, entire frame efficiency is largely reduced. Further, when it is assumed that the common information is transmitted through each beam, different spreading codes must be assigned to each beam so that a user, i.e., a mobile station (MS), can separate beams. Accordingly, even though the same information is originally transmitted, spreading codes corresponding to the number of beams must be used redundantly. Further, even though the number of spreading codes used is determined by the number of beams that are used, more than one information segment must be transmitted in one spreading segment. Accordingly, the number of spreading codes assigned to individual data is reduced and, thus, frame efficiency is reduced.

In order to solve the aforementioned problems, a method in which a multibeam generated from an array antenna is synthesized to form a radial pattern having non-directivity and only a common channel is used through the radial pattern.

However, in a system acquiring a beam diversity gain, when a common channel is transmitted through a non-directional radial pattern, the method has a problem in that the beam diversity gain is lost.

### SUMMARY OF THE INVENTION

Accordingly, the present invention has been designed to solve the above and other problems occurring in the prior art and it is an object of the present invention to provide a system and method for transmitting common data to multiple users by means of a multibeam, without losing a beam diversity gain in a mobile communication system.

It is another object of the present invention to provide a common data transmission system and method for performing a space-time coding for all beams included in a multibeam for transmitting common data, assigning the space-time coded common data to all beams included in the multibeam, and transmitting the common data to multiple users.

In order to accomplish the above and other objects, according to one aspect of the present, there is provided a common channel transmission system for transmitting common data to multiple users via multi-beams. The common channel transmission system includes: a common data coding means for performing a space-time coding for the common data of beams included in the multi-beam; and a data transmission means for assigning the common data space-time coded by the common data coding means to the beams included in the multi-beam and transmitting the common data to the multiple users.

According to another aspect of the present, there is provided a method for transmitting common data to multiple users by means of a multi-beam over a common channel. The method includes the steps of: space-time coding the common data of beams included in the multi-beam; assigning the space-time coded common data to the beams included in the multi-beam; and transmitting the common data to the multiple users.

According to yet another aspect of the present, there is provided a computer system for transmitting common data to multiple users by means of a multibeam. The computer system includes: a processing means for space-time coding the common data of beams included in the multibeam; and a program module having a program for enabling a series of processing that assigns the space-time coded common data to the beams included in the multibeam to be executed in the computer.

According to another aspect of the present, there is provided a computer system processing method for a computer system for transmitting common data to multiple users by means of a multibeam. The computer system processing method includes the steps of: space-time coding the common data of beams included in the multibeam; and assigning the space-time coded common data to the beams included in the multibeam.

### BRIEF DESCRIPTION OF THE DRAWINGS

The above and other objects, features, and advantages of the present invention will be more apparent from the following detailed description taken in conjunction with the accompanying drawings, in which:

FIG. 1 is a block diagram illustrating a transmitter according to a first embodiment of the present invention;

FIG. 2 is a block diagram illustrating a receiver according to the first embodiment of the present invention,

FIG. 3 is a view illustrating transmission of a beam pair for data channel transmission and an entire beam for a common channel according to the present invention;

FIG. 4 is a block diagram illustrating a more detailed construction of the transmitter according to the first embodiment of the present invention;

FIG. 5 is a graph illustrating a beam pattern of a multibeam according to the present invention;

FIG. 6 is a view illustrating a frame in the transmitter according to the first embodiment of the present invention;

FIG. 7 is a block diagram illustrating a transmitter according to the second embodiment of the present invention;

FIG. 8 is a view illustrating a corresponding relation between an extended space-time coding matrix and a beam pattern of a multibeam according to the present invention;

FIG. 9 is a block diagram illustrating a transmitter according to the third embodiment of the present invention;

FIG. 10 is a view illustrating a processing step in the transmitter according to the third embodiment of the present invention;

FIG. 11 is a view illustrating a code multiplexing of a common channel and a code multiplexing of a data channel according to the third embodiment of the present invention;

FIG. 12 is a block diagram illustrating a transmitter according to the fourth embodiment of the present invention;

FIG. 13 is a view illustrating a processing step in the transmitter according to the fourth embodiment of the present invention;

FIG. 14 is a view illustrating a code multiplexing of a common channel and a code multiplexing of a data channel according to the fourth embodiment of the present invention;

FIG. 15 is a view illustrating a 2-code frame of the transmitter according to the fourth embodiment of the present invention;

FIG. 16 is a view illustrating a 4-code frame of the transmitter according to the fourth embodiment of the present invention;

FIG. 17 is a block diagram illustrating a more detailed construction of the transmitter according to the fourth embodiment of the present invention;

FIG. 18 is a block diagram illustrating the construction of the transmitter according to the first to the fourth embodiment of the present invention; and

FIG. 19 is a view illustrating a transmission process of a common channel by a synthesis beam.

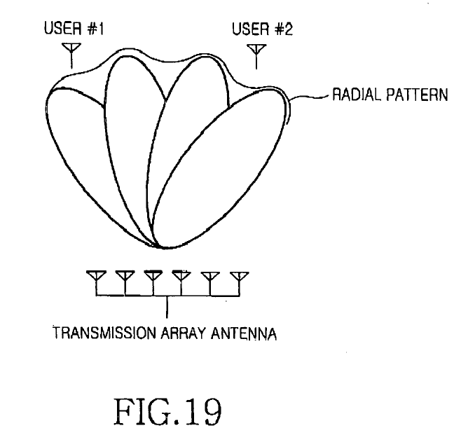

### DETAILED DESCRIPTION OF THE PREFERRED EMBODIMENT

Hereinafter, a preferred embodiment according to the present invention will be described in detail with reference to the accompanying drawings. In the following description of the present invention, a detailed description of known functions and configuration incorporated herein will be omitted when it may obscure the subject matter of the present invention.

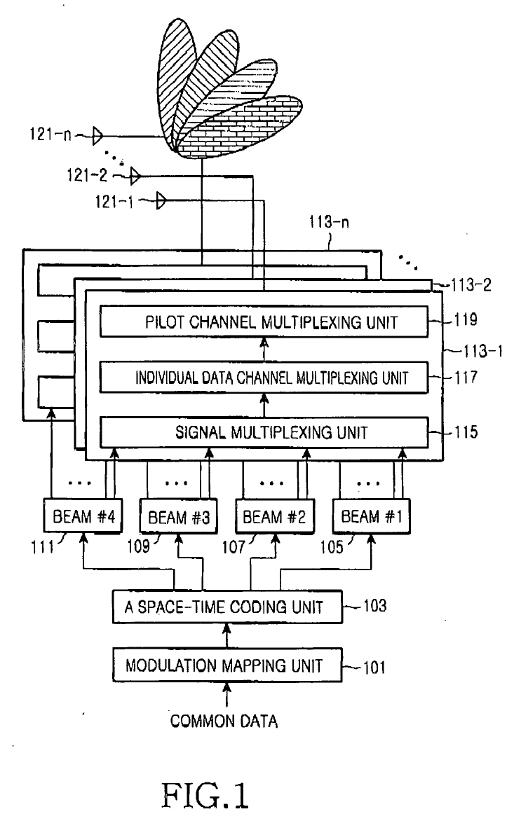

FIG. 1 is a block diagram illustrating a transmitter in the common channel transmission system according to a first embodiment of the present invention. Referring to FIG. 1, the transmitter includes a modulation mapping unit 101, a space-time coding unit (or common data coding unit) 103, at least one beam generator (e.g., a first to a fourth beam generator 105, 107, 109, and 111), a plurality of data transmission units (e.g., n number of data transmission units 113-1 to 113-n, n represents a natural number greater than 2), and a plurality of transmission antennas (e.g., n number of transmission antennas 121-1 to 121-n). Further, each of the data transmission units 113-1 to 113-n includes a signal multiplexing unit 115, an individual data channel multiplexing unit 117, and a pilot channel multiplexing unit 119.

In FIG. 1, the transmitter inputs common data, that is, broadcast data such as common control information, broadcasting, etc., to a plurality of users and then transmits the input common data to the plurality of users by means of a multibeam. More specifically, the modulation mapping unit 101 maps the input common data to a modulation point signal and outputs the mapped common data to the space-time coding unit 103. The space-time coding unit 103 receives the mapped common data from the modulation mapping unit 101 and then performs space-time coding for the input common data throughout all beams included in the multibeam.

Hereinafter, a detailed description will be given on an assumption that the number of beams (beam number) constituting the multibeam is 4.

The space-time coding unit 103 classifies transmission symbols of a channel of the input common data every four symbols and generates one transmission symbol vector to be [S1, S2, S3, and S4]. The space-time coding unit 103 codes the transmission symbol vector using a quasi-orthogonal space-time coding matrix Ω. The space-time coding matrix Ω may be expressed by Equation 1 below.

$$Ω = [ \begin{matrix}{S}_{1} & {S}_{2} & {S}_{3} & {S}_{4} \\ - {S}_{2}^{*} & {S}_{1}^{*} & - {S}_{4}^{*} & {S}_{3}^{*} \\ {S}_{3} & {S}_{4} & {S}_{1} & {S}_{2} \\ - {S}_{4}^{*} & {S}_{3}^{*} & - {S}_{2}^{*} & {S}_{1}^{*}\end{matrix} ] \qquad Equation 1$$

In a system using a multibeam, columns of the space-time coding matrix Ω as shown in Equation 1 are respectively assigned to the first to the fourth beam generator 105, 107, 109, and 111 and rows of the space-time coding matrix Ω are assigned to time, that is, time slots representing a transmission sequence of symbols. A more detailed description will be given below.

Herein, for convenience of description, a beam corresponding to the first beam generator 105 is expressed by #1, a beam corresponding to the second beam generator 107 is expressed by #2, a beam corresponding to the third beam generator 109 is expressed by #3, and a beam corresponding to the fourth beam generator 111 is expressed by #4.

1) In a time point 1, the space-time coding matrix Ω is assigned to the beams #1 to #4 as follows:
(#1, #2, #3, #4)=(S₁, S₂, S₃, S₄).

2) In a time point 2, the space-time coding matrix Ω is assigned to the beams #1 to #4 as follows:
(#1, #2, #3, #4)=(−S₂*, S₁*, −S₄*, S₃*).

3) In a time point 3, the space-time coding matrix Ω is assigned to the beams #1 to #4 as follows:
(#1, #2, #3, #4)=(S₄, S₃, S₁, S₂).

4) In a time point 4, the space-time coding matrix Ω is assigned to the beams #1 to #4 as follows:
(#1, #2, #3, #4)=(−S₄*, S₃*, −S₂*, S₁*).

As described above, the space-time coding matrix Ω is assigned to the beams #1 to #4 according to each time. Then, each symbol assigned according to each time is subjected to a beam steering and is transmitted to the data transmission units 113-1 to 113-n. Each of the data transmission units 113-1 to 113-n includes the signal multiplexing unit 115, the individual data channel multiplexing unit 117, the pilot channel multiplexing unit 119, and a plurality of antennas 121-1 to 121-n. Further, each of the data transmission units 113-1 to 113-n assigns the space-time coded common data to all beams #1 to #4 (105, 107, 109, and 111) included in the multibeam and transmits the common data to the multiple users.

The signal multiplexing unit 115 adds signal components of each symbol of the common data channel, which has been assigned to all beams #1 to #4 (105, 107, 109, and 111) by the space-time coding unit 103 and input to the data transmission unit 113-1 after the beam steering, and outputs the added common data channel to the individual data channel multiplexing unit 117.

The individual data channel multiplexing unit 117 receives the common data channel added by the signal multiplexing unit 115. Further, the individual data channel multiplexing unit 117 multiplexes the common data channel with a data channel (i.e., an individual data channel) having individual data different according to each of the multiple users if necessary, instead of the common data. Thereafter the individual data channel multiplexing unit 117 outputs a multiplexing signal of the common data channel and the individual data channel to the pilot channel multiplexing unit 119.

The pilot channel multiplexing unit 119 receives the multiplexing signal of the common data channel and the individual data channel from the individual data channel multiplexing unit 117, multiplexes the multiplexing signal with a channel (i.e., a pilot channel) having a pilot signal if necessary, and outputs the multiplexed signal to the antenna 121-1.

Then the antenna 121-1 is included in a transmission array antenna with the other antennas 121-2 to 121-n and transmits the multiplexed signal input from the pilot channel multiplexing unit 119.

The common data input to the transmitter according to the first embodiment of the present invention is space-time coded by the space-time coding unit 103 in beams #1 to #4 (105, 107, 109, and 111) included in the multibeam, and sent from the transmission array antennas 121-1 to 121-n of the data transmission units 113-1 to 113-n to the multiple users (e.g., a receiver of the present invention which will be described below). That is, the multibeam output from the array antenna of the transmitter is received in the receiver.

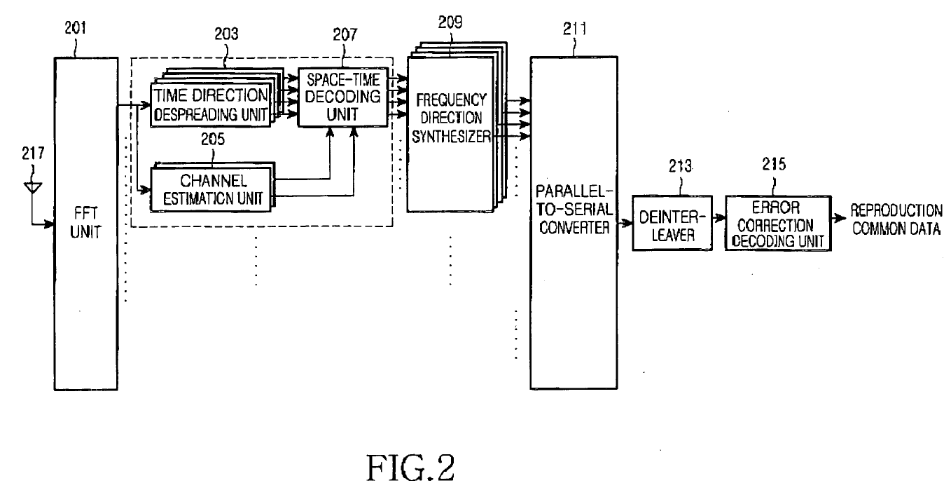

FIG. 2 is a block diagram illustrating a receiver according to the first embodiment of the present invention. Referring to FIG. 2, the receiver includes a receiving antenna 217, a Fast Fourier Transform (FFT) unit 201, a plurality of time direction despreading units 203, a plurality of channel estimation units 205, a plurality of space-time decoding units 207, a plurality of frequency direction synthesizers 209, a parallel-to-serial converter 211, a de-interleaver 213, and an error correction decoding unit 215. The FFT unit 201 receives a received signal from the receiving antenna 217, downconverts the received signal, and eliminates a guard interval from the received signal. Further, the FFT unit 201 converts the received signal to a subcarrier signal through the FFT and outputs the subcarrier signal to the time direction despreading unit 203 and the channel estimation unit 205.

The time direction despreading unit 203 receives the subcarrier signal and generates a reception replica of a pilot signal from each transmission antenna by means of the pilot signal, a spreading code for the pilot signal, and a channel estimated value acquired from the channel estimation unit 205. Simultaneously, the time direction dispreading unit 203 subtracts a reception pilot signal replica from the subcarrier signal for which the FFT has been performed, and performs a despreading in a time direction for the subcarrier signal, from which the pilot signal has been subtracted, using a spreading code assigned to a user of the receiver.

The channel estimation unit 205 eliminates a modulation phase component of the pilot signal from the signal despread by the time direction despreading unit 203, estimates channel response, and outputs a result of the estimation to the space-time decoding unit 207.

The space-time decoding units 207 despreads the subcarrier signal using the spreading code used by the user of the receiver and performs a space-time decoding using the channel estimated value from the channel estimation unit 205, for the signal despread by the time direction despreading unit 203.

The frequency direction synthesizer 209 receives space-time decoding output from the space-time decoding units 207, performs a synthesis in a frequency direction, and outputs the synthesized signal to the parallel-to-serial converter 211. The parallel-to-serial converter 211 converts the synthesized signal synthesized by the frequency direction synthesizer 209 to a serial signal and outputs the serial signal to the deinterleaver 213.

The deinterleaver 213 receives the output signal from the parallel-to-serial converter 211, reverses the sequence of data, and outputs a signal of data in reverse sequence to the error correction decoding unit 215.

The error correction decoding unit 215 receives the output signal from the deinterleaver 213, performs an error correction for the signal, and outputs reproduced common data.

Hereinafter, an operation when the receiver receives the multibeam output from the array antennas 121-1 to 121-n of the transmitter will be described below.

1) The receiver receives a received signal r₁at the time 1. Herein, the received signal r₁ may be expressed by Equation 2.
r₁=h₁s₁+h₂s₂+h₃s₃+h₄s₄ Equation 2

2) The receiver receives a received signal r₂ at the time 2. Herein, the received signal r₂ may be expressed by Equation 3.
r₂=−h₁s*₂+h₂s*₁−h₃s*₄+h₄s*₃ Equation 3

3) The receiver receives a received signal r₃ at the time 3. Herein, the received signal r₃ may be expressed by Equation 4.
r₃=h₁s₃+h₂s₄+h₃s₁+h₄s₂ Equation 4

4) The receiver receives a received signal r₄ at the time 4. Herein, the received signal r₄ may be expressed by Equation 5.
r₄=h₁s*₄+h₂s*₃−h₃s*₂+h₄s*₁ Equation 5

In Equations 2 to 5, h₁, h₂, h₃, and h₄ each represent a channel response to a mobile station in each beam. When a space-time decoding is performed for each of the received signals r₁ to r₄ according to Equations 2 to 5 by means of estimated values of the channel responses h₁ to h₄, each symbol can be defined by Equations 6 to 9 below.

The symbol s₁ is defined by Equation 6 below.

$$\begin{matrix}{\hat{s}}_{1} = {h}_{1}^{*} {r}_{1} + {h}_{2} {r}_{2}^{*} + {h}_{3}^{*} {r}_{3} + {h}_{4} {r}_{4}^{*} \\ = \{ {\sum }_{i = 1}^{4} {\vert {h}_{i} \vert}^{2} \} {s}_{1} + 2 Re ( {h}_{1} {h}_{3}^{*} + {h}_{2} {h}_{4}^{*} ) {s}_{3}\end{matrix} \qquad Equation 6$$

The symbol s₂ is defined by Equation 7 below.

$$\begin{matrix}{\hat{s}}_{2} = {h}_{2}^{*} {r}_{1} - {h}_{1} {r}_{2}^{*} + {h}_{4}^{*} {r}_{3} - {h}_{3} {r}_{4}^{*} \\ = \{ {\sum }_{i = 1}^{4} {\vert {h}_{i} \vert}^{2} \} {s}_{2} + 2 Re ( {h}_{1} {h}_{3}^{*} + {h}_{2} {h}_{4}^{*} ) {s}_{4}\end{matrix} \qquad Equation 7$$

The symbol s₃ is defined by Equation 8 below.

$$\begin{matrix}{\hat{s}}_{3} = {h}_{3}^{*} {r}_{1} + {h}_{4} {r}_{2}^{*} + {h}_{1}^{*} {r}_{3} + {h}_{2} {r}_{4}^{*} \\ = \{ {\sum }_{i = 1}^{4} {\vert {h}_{i} \vert}^{2} \} {s}_{3} + 2 Re ( {h}_{1} {h}_{3}^{*} + {h}_{2} {h}_{4}^{*} ) {s}_{1}\end{matrix} \qquad Equation 8$$

The symbol s₄ is defined by Equation 9 below.

$$\begin{matrix}{\hat{s}}_{4} = {h}_{4}^{*} {r}_{1} - {h}_{3} {r}_{2}^{*} + {h}_{2}^{*} {r}_{3} - {h}_{1} {r}_{4}^{*} \\ = \{ {\sum }_{i = 1}^{4} {\vert {h}_{i} \vert}^{2} \} {s}_{4} + 2 Re ( {h}_{1} {h}_{3}^{*} + {h}_{2} {h}_{4}^{*} ) {s}_{2}\end{matrix} \qquad Equation 9$$

In the second portions (“Re” parts) of Equations 6 to 9 represents an item of a real part and is interfered by another signal in a transmission symbol vector. However, when each beam has a low sidelobe and is spread with a narrow angle, the directionality of the beam allows only no more than two beams to reach a mobile station with an increased signal power and prevents signals of other beams from reaching the mobile station.

That is, the channel responses h₁ and h₃ and the channel responses h₁ and h₃ each satisfy the following condition:
|h₁|>>|h₃| or |h₁|<<|h₃|; and (1)
|h₂|>>|h₄| or |h₂|<<|h₄|. (2)

Accordingly, the h₁h₃* and h₂h₄* have values that are small enough to be neglected. Therefore, interference from another signal can be prevented from occurring.

By a closed loop beam selection, the receiver designates a beam pair (e.g., two beams) for data channel transmission, which has a maximum power sum of channel estimated values, for the transmitter. Accordingly, the receiver performs a decoding using the channel estimated values from the two designated beams transmitted from the transmitter.

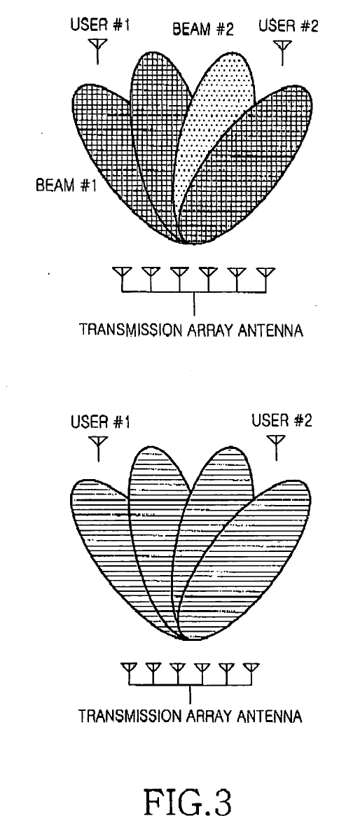

FIG. 3 is a view illustrating a transmission of a beam pair for data channel transmission and an entire beam for a common channel according to the present invention. Referring to FIG. 3, it is assumed that a receiver user #1 is located around the center of beam #1 and beam #2 and designates the beams #1 and #2 by a beam selection. Therefore, only parts containing the h₁ and the h₂ are calculated.

Herein, when it is considered that the h₃=0 and the h₄=0, each transmission symbol can be defined by Equations 10 to 13 below. More specifically, the transmission symbol s₁ can be defined by Equation 10 below.

$$\begin{matrix}{\hat{s}}_{1} = {h}_{1}^{*} {r}_{1} + {h}_{2} {r}_{2}^{*} \\ = ( {\vert {h}_{1} \vert}^{2} + {\vert {h}_{2} \vert}^{2} ) {s}_{1}\end{matrix} \qquad Equation 10$$

The transmission symbol s₂ can be defined by Equation 11 below.

$$\begin{matrix}{\hat{s}}_{2} = {h}_{2}^{*} {r}_{1} - {h}_{1} {r}_{2}^{*} \\ = ( {\vert {h}_{1} \vert}^{2} + {\vert {h}_{2} \vert}^{2} ) {s}_{2}\end{matrix} \qquad Equation 11$$

The transmission symbol a₃ can be defined by Equation 12 below.

$$\begin{matrix}{\hat{s}}_{3} = {h}_{1}^{*} {r}_{3} + {h}_{2} {r}_{4}^{*} \\ = ( {\vert {h}_{1} \vert}^{2} + {\vert {h}_{2} \vert}^{2} ) {s}_{3}\end{matrix} \qquad Equation 12$$

The transmission symbol s₄ can be defined by Equation 13 below.

$$\begin{matrix}{\hat{s}}_{4} = {h}_{2}^{*} {r}_{3} - {h}_{1} {r}_{4}^{*} \\ = ( {\vert {h}_{1} \vert}^{2} + {\vert {h}_{2} \vert}^{2} ) {s}_{4}\end{matrix} \qquad Equation 13$$

Accordingly, the transmission symbol vector [S₁, S₂, S₃, S₄] can be decoded through a maximum ratio synthesis of two branches.

Additionally, in FIG. 3, the example shows a case in which the receiver is located around the center of the beam #1 and the beam #2. However, even though another user is located at another place, said another user can also decode the transmission symbol vector [S₁, S₂, S₃, S₄]. Accordingly, the present invention can transmit common channels to all users within the multibeam.

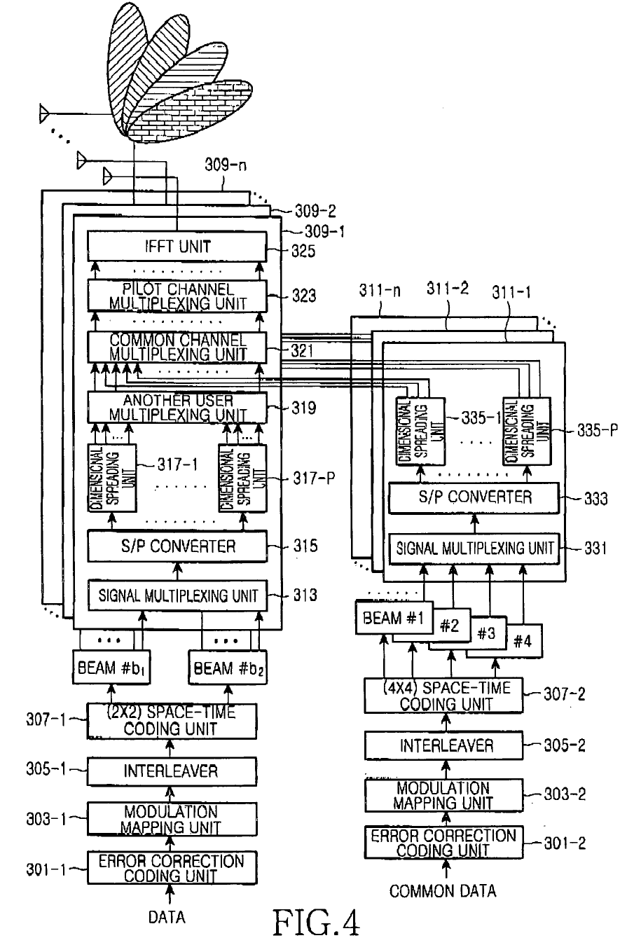

FIG. 4 is a block diagram illustrating a more detailed construction of the transmitter according to the first embodiment of the present invention. The transmitter inputs individual data and common data, performs a two-dimensional spreading and multiplexing for the input data, and transmits the multiplexed data.

Referring to FIG. 4, the transmitter includes error correction coding units 301-1 and 301-2, modulation mapping units 303-1 and 303-2, interleavers 305-1 and 305-2, space-time coding units 307-1 and 307-2, and data transmission units 309-1 to 309-n/311-1 to 311-n (where n represents a natural number more than 2).

The error correction coding units 301-1 and 301-2 receive transmission data, perform an error correction coding for the received transmission data, and output the coded transmission data to the modulation mapping units 303-1 and 303-2, respectively. The modulation mapping units 303-1 and 303-2 receive the coded transmission data from the error correction coding units 301-1 and 301-2, map the coded transmission data to a modulation constellation, and output the mapped data to the interleavers 305-1 and 305-2, respectively.

In order to spread a burst error, the interleavers 305-1 and 305-2 receive the mapped data, change the sequence of the data, and output the data having a changed sequence to the space-time coding units 307-1 and 307-2, respectively.

The space-time coding units 307-1 and 307-2 each code signals output from the interleavers 305-1 and 305-2 using a 2×2 orthogonal space-time coding matrix and a 4×4 quasi-orthogonal space-time coding matrix as shown in Equation 1, assign the space-time coding output to beams represented by a selection beam index received from the transmitter, and output the space-time coding output. For example, when a selection beam index assigning space-time coding output of individual data represents the beams #1 and #2, the space-time coding unit 307-1 assigns the space-time coding output to the beams #1 and #2, and outputs the space-time coding output to the corresponding data transmission units 309-1 to 309-n. Further, when space-time coding output of common data is assigned to all beams #1 to #4 included in the multibeam, the space-time coding unit 307-2 assigns the space-time coding output to the beams #1 to #4, and outputs the space-time coding output to the corresponding data transmission units 311-1 to 311-n.

Each of the corresponding data transmission units 309-1 to 309-n includes a multiplexing unit 313, a serial-to-parallel converter 315, two-dimensional spreading units 317-1 to 317-p (where p represents a natural number greater than 2), another user multiplexing unit 319, a common channel multiplexing unit 321, a pilot channel multiplexing unit 323, and an inverse Fast Fourier Transform (IFFT) unit 325. Further, each of the corresponding data transmission units 311-1 to 311-n includes a multiplexing unit 331, a serial-to-parallel converter 333, and two-dimensional spreading units 335-1 to 335-p (where p represents a natural number greater than 2).

The multiplexing unit 313 receives the space-time coding output assigned to the selection beam index by the space-time coding units 307-1, multiplexes a plurality of beams, and outputs the multiplexed beam to the serial-to-parallel converter 315. For example, the multiplexing unit 313 multiplies the space-time coding transmission symbol by an array weight in the transmission array antenna, and multiplexes two beams (beams #1 and #2).

Similar to the multiplexing unit 313, the multiplexing unit 331 receives the space-time coding output assigned to all beams #1 to #4 included in the multibeam by the space-time coding units 307-2, multiplexes all beams, and outputs the multiplexed beam to the serial-to-parallel converter 333. For example, the multiplexing unit 331 multiplies the space-time coding transmission symbol by the array weight in the transmission array antenna, and multiplexes four beams (beams #1 to #4).

The serial-to-parallel converters 315 and 333 each receive the beam space-time coding transmission symbol multiplexed for multiple beams, perform serial-to-parallel conversion for the input beam space-time coding transmission symbol every two symbols or four symbols, and output the serial-to-parallel converted symbol to the two-dimensional spreading units 317-1 to 317-p/335-1 to 335-p.

The two-dimensional spreading units 317-1 to 317-p/335-1 to 335-p receive the serial-to-parallel converted beam space-time coding transmission symbol, and assign the received serial-to-parallel converted beam space-time coding transmission symbol to spreading segments, respectively. Further, the two-dimensional spreading units 317-1 to 317-p/335-1 to 335-p perform a two-dimensional spreading of a time direction and a frequency direction for each spreading segment by means of a Walsh code, and then output the two-dimensional spread segments to said another user multiplexing unit 319.

In the two-dimensional spread segment, a spreading area is set by the number (SFTime) of OFDM symbols in a time direction in a segment and the number (SFFreq) of subcarriers in a frequency direction in the segment. Further, a spreading code of the assigned spreading [a time direction spreading ratex a frequency direction spreading rate (SFTimex SFFreq)] is used as a spreading code. The two-dimensional spreading units 317-1 to 317-p/335-1 to 335-p repeat a spreading processing step of performing a spreading in a time direction in an initial subcarrier and performing a spreading in a time direction in a neighbor subcarrier, thereby performing a two-dimensional spreading of a time direction and a frequency direction.

The another user multiplexing unit 319 multiplexes two symbols in each time direction, which are output from the two-dimensional spreading units 317-1 to 317-p, in the same spreading area. Further, the another user multiplexing unit 319 performs a multiplexing for the beam space-time coding transmission symbol having been spread in two-dimensions of both a time direction and a frequency direction between multiple users, and then outputs the multiplexed symbol to the common channel multiplexing unit 321.

The common channel multiplexing unit 321 multiplexes spreading data (i.e., individual data), to which another user signal is multiplexed, input from said another user multiplexing unit 319 and spreading data (common data) input from the two-dimensional spreading units 335-1 to 335-p in the same spreading area, and then outputs the multiplexed data to the pilot channel multiplexing unit 323.

The pilot channel multiplexing unit 323 spreads a pilot signal for each beam to a time direction, multiplexes the spread pilot signal with multiplexed spreading data of another user, and then outputs the multiplexed signal to the IFFT unit 325.

The IFFT unit 325 converts the multiplexed signal to a time domain signal using an IFFT. Further, the IFFT unit 325 up-converts the time domain signal to a carrier frequency by adding a guard interval (GI) to the time domain signal, and outputs a transmission signal to the transmission array antenna.

The transmission array antenna includes multiple antennas (n antennas) corresponding to the data transmission units 309-1 to 309-n, and radiates multiple transmission signals input from the IFFT units 325 of the data transmission units 309-1 to 309-n.

As illustrated in FIG. 4, when common data is input, the transmitter according to the present invention performs an error correction coding for the common data, and maps the coded data to a modulation signal point. Further, the mapped signal has a random transmission sequence by the interleaver and is space-time coded by means of the 4×4 space-time coding matrix.

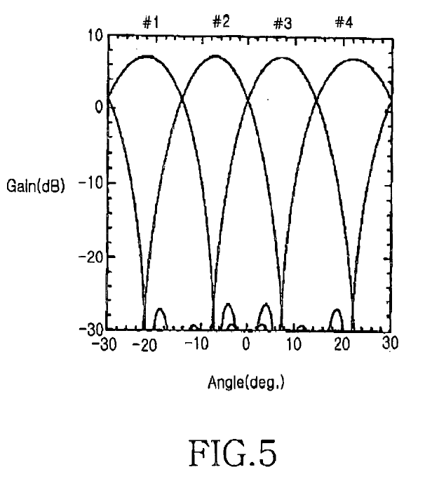

FIG. 5 illustrates an output in a space direction of the space-time coding unit. More specifically, FIG. 5 is a graph illustrating a beam pattern of a multibeam according to the present invention. Accordingly, each beam included in the multibeam is steered to be multiplexed.

The beam multiplexed signal is serial-to-parallel converted every four symbols and is spread by a two-dimensional spreading. The spread signal is multiplexed with a spread signal generated from individual data, is multiplexed with a pilot signal again, is converted to a time domain signal, and then transmitted.

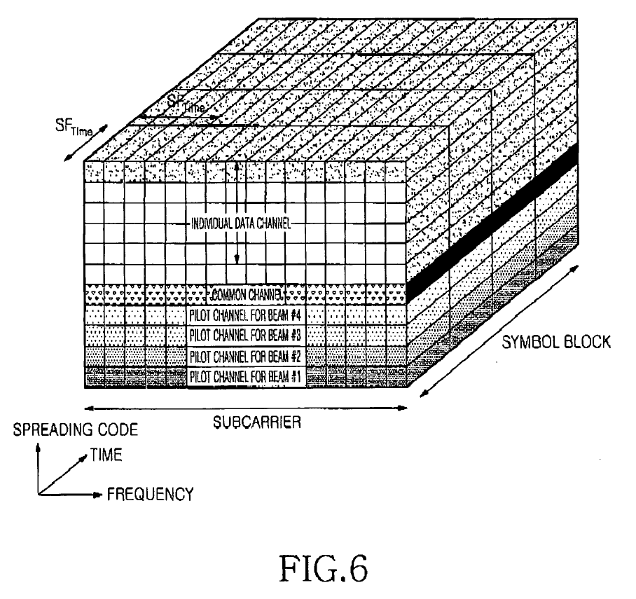

FIG. 6 is a view illustrating a frame in the transmitter according to the first embodiment of the present invention. Referring to FIG. 6, transmission data of each channel (pilot channels for beams #1 to #4, a common channel and an individual data channel) are spread in two-dimensions of a time direction and a frequency direction, and then multiplexed in the same spreading area. That is, in each spreading segment, the transmission data is spread in two-dimensions of the time direction and the frequency direction by means of a Walsh code. Herein, a spreading code available according to a used beam pair is used as a spreading code in the two-dimensional spreading.

Further, the spreading signal is multiplexed with another user signal obtained through the aforementioned process. Thereafter, each subcarrier in a two-dimensional spreading area spreads a pilot signal using multiple spreading codes that are perpendicular to a spreading code for a user signal spreading, and then multiplexes the spread pilot signal with the user signal.

A frame signal generated through the aforementioned process is converted to a time domain signal using an IFFT. Further, a guard interval is added to the converted signal and the converted signal is up-converted to a carrier frequency. Finally, the converted signal is transmitted from the array antennas.

The receiver converts a signal received from the transmitter to a reception subcarrier signal using an FFT, and despreads each subcarrier in a time direction using a spreading code to which a pilot signal for beam has been assigned. Further, the receiver eliminates a modulation component of the pilot signal from the despread signal, thereby acquiring a channel estimated value from beam.

Further, the receiver suppresses a signal causing interference by performing despreading in a time direction in a spreading code to which a user has been assigned. The receiver performs a space-time coding for the signal to synthesize the signal in a frequency direction. Then, the receiver deinterleaves the despread signal to perform a decoding of an error correction and acquires a reproduction bit-based signal.

As described above, in the common channel transmission system according to an embodiment of the present invention, when an OFDM-CDM system performs an individual beam transmission for each user by means of a fixed multibeam, transmission is performed over a common channel to all users by means of the same fixed beam. Accordingly, common data can be transmitted to multiple users by means of the multibeam without losing a beam diversity gain. Further, according to the common channel transmission system of the present invention, a common data channel and an individual data channel can be easily multiplexed, thereby easily constructing the system.

Furthermore, according to the common channel transmission system of the present invention, row vectors of a space-time coding matrix are code-multiplexed to the same spreading area, thereby preventing reception characteristics from deterioration due to the influence of a Doppler spread according to an increase of the matrix size of the space-time coding matrix. Through the aforementioned construction, the common channel transmission system can easily deal with even a user moving at a higher speed. Accordingly, the present invention can suppress the deterioration of transmission characteristics and improve the performance of the system.

In other words, the common channel transmission system of the present invention performs a space-time coding throughout an entire transmission beam, thereby transmitting the same information to the entire beam area.

Further, even though a used space-time coding matrix does not always maintain a complete orthogonality, the common channel transmission system of the present invention can suppress occurrence of self interference component by using a multibeam of low sidelobe, use a space-time coding matrix of a square matrix, and suppress the deterioration of tolerance of a channel for time change.

Until now, the common channel transmission system including the transmitter and the receiver according to the first embodiment of the present invention has been described. Hereinafter, other embodiments for the common channel transmission system according to the present invention will be described.

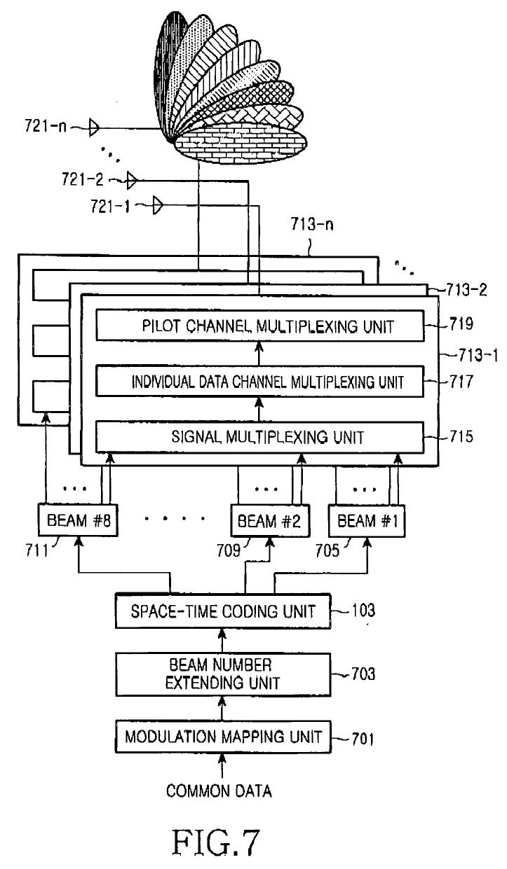

FIG. 7 is a block diagram illustrating a transmitter in the common channel transmission system according to the second embodiment of the present invention. The common channel transmission system according to the second embodiment of the present invention is different from that of the first embodiment of the present invention in that the common channel transmission system of the second embodiment extends the beam number of a multibeam assigning space-time coded common data.

Referring to FIG. 7, the transmitter further includes a beam number extending unit 703 disposed at a prior stage of a space time coding unit 103. When the beam number of a multibeam assigning the space-time coded common data is extended, the beam number extending unit 703 cyclically extends column vectors of a space-time coding matrix and enables the space-time coding matrix to become a space-time coding matrix having column vectors of the number equal to the beam number. The space-time coding unit 103 performs a space-time coding for common data throughout all beams by means of the space-time coding matrix extended by the beam number extending unit 703. Further, data transmission units 713-1 to 713-n each assign the common data space-time coded by the space-time coding unit 103 to all beams #1 to #8 (705, 709, . . . , 711) included in the multibeam and transmit the common data to multiple users.

Generally, when the beam number is extended, the number of columns of a space-time coding matrix increases according to an extended beam number, and thus the number of rows also increases. However, when the number of rows increases in this way, the rows are assigned to symbols in a time direction. Therefore, tolerance of a channel for time change is deteriorated.

In order to solve the aforementioned problems, a method may be considered, which increases the tolerance of the channel for time change using code multiplexing. However, because such a method must use many orthogonal codes in comparison to a method, which does not use the code multiplexing, the method has a problem in that it restricts a multiple number of user signals.

Accordingly, when it is assumed that a space-time coding matrix using four beams is defined by Equation 14 below and the space-time coding matrix is extended to be a space-time coding matrix having eight beams, the space-time coding matrix using four beams is extended to the space-time coding matrix having eight beams as shown in Equation 15 by repeatedly using column vectors defined by Equation 14.

$$\begin{matrix}Ω = [ \begin{matrix}{S}_{1} & {S}_{2} & {S}_{3} & {S}_{4} \\ - {S}_{2}^{*} & {S}_{1}^{*} & - {S}_{4}^{*} & {S}_{3}^{*} \\ {S}_{3} & {S}_{4} & {S}_{1} & {S}_{2} \\ - {S}_{4}^{*} & {S}_{3}^{*} & - {S}_{2}^{*} & {S}_{1}^{*}\end{matrix} ] & Equation 14 \\ Ω = [ \begin{matrix}{S}_{1} & {S}_{2} & {S}_{3} & {S}_{4} & {S}_{1} & {S}_{2} & {S}_{3} & {S}_{4} \\ - {S}_{2}^{*} & {S}_{1}^{*} & - {S}_{4}^{*} & {S}_{3}^{*} & - {S}_{2}^{*} & {S}_{1}^{*} & - {S}_{4}^{*} & {S}_{3}^{*} \\ {S}_{3} & {S}_{4} & {S}_{1} & {S}_{2} & {S}_{3} & {S}_{4} & {S}_{1} & {S}_{2} \\ - {S}_{4}^{*} & {S}_{3}^{*} & - {S}_{2}^{*} & {S}_{1}^{*} & - {S}_{4}^{*} & {S}_{3}^{*} & - {S}_{2}^{*} & {S}_{1}^{*}\end{matrix} ] & Equation 15\end{matrix}$$

That is, when the beam number of the multibeam assigning the space-time coded common data is extended, the column vectors of the space-time coding matrix are cyclically-extended and the space-time coding matrix is extended to a space-time coding matrix having column vectors of the number equal to the beam number. Through such an extension, the matrix can be extended to a matrix having many beams number without increasing the number of rows.

As described above, according to the common channel transmission system of the second embodiment of the present invention, the column vectors of the space-time coding matrix are cyclically-extended, thereby creating an extended space-time coding matrix.

Through such a construction, the present invention can extend a space-time coding matrix to another space-time coding matrix having many beams number without increasing the number of rows.

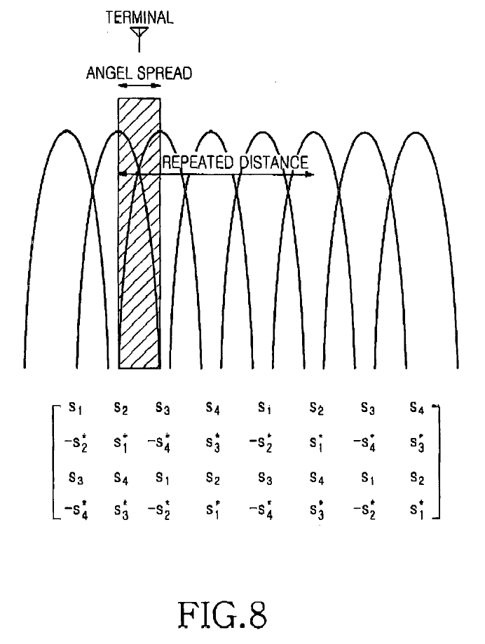

FIG. 8 is a view illustrating the corresponding relation between the extended space-time coding matrix and the beam pattern of the multibeam according to the present invention. As illustrated in FIG. 8, when a spread of a transmission angle is narrow, a signal transmitted from a first beam having the same column vector as that of a second beam does not reach a receiver. Accordingly, this is the same as the case described in the first embodiment of the present invention. Herein, because the receiver already understands a corresponding relation between the beam number and the column vector, the receiver can perform a decoding a received signal.

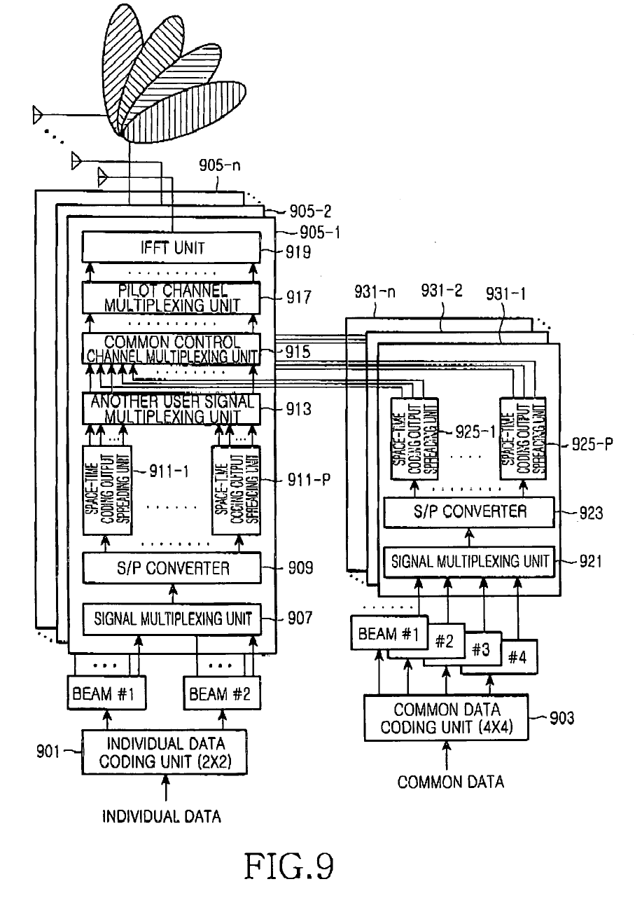

FIG. 9 is a block diagram illustrating a transmitter in the common channel transmission system according to the third embodiment of the present invention. The common channel transmission system according to the third embodiment of the present invention is different from that of the first embodiment of the present invention in that the common channel transmission system of the third embodiment multiplexes the common data transmission scheme with a beam space transmission diversity scheme for data channel transmission or an inter-code beam space transmission diversity scheme.

Referring to FIG. 9, an individual data coding unit 901 and a common data coding unit 903 each perform a space-time coding for individual data and common data, which are to be transmitted to multiple users, multiplex the coded data, perform a serial-to-parallel conversion for the multiplexed data, and output the converted data to space-time coding output spreading units 911-1 to 911-p/925-1 to 925-p.

The space-time coding output spreading units 911-1 to 911-p/925-1 to 925-p spread space-time coding output of the individual data and space-time coding output of the common data in a time direction and a frequency direction, respectively, and multiplex the spread data. Further, the space-time coding output spreading units 911-1 to 911-p/925-1 to 925-p assign the space-time coding output of the common data to all beams included in a multibeam and enable the space-time coding output to be transmitted from data transmission units to multiple users.

Simultaneously, the space-time coding output spreading units 911-1 to 911-p/1925-1 to 925-p assign the space-time coding output of the individual data to beam space of the multibeam and enables the space-time coding output to be transmitted from the data transmission units to the multiple users. That is, in the present invention employing an OFDM-CDM scheme, as illustrated in FIG. 9, the common data are coded in a 4×4 space-time coding matrix and a beam steering is performed for each column vector.

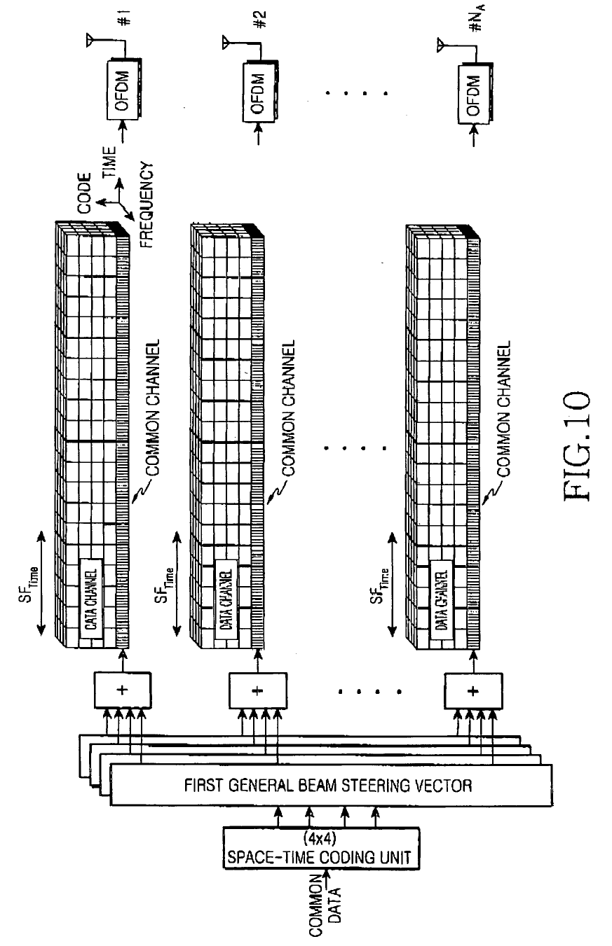

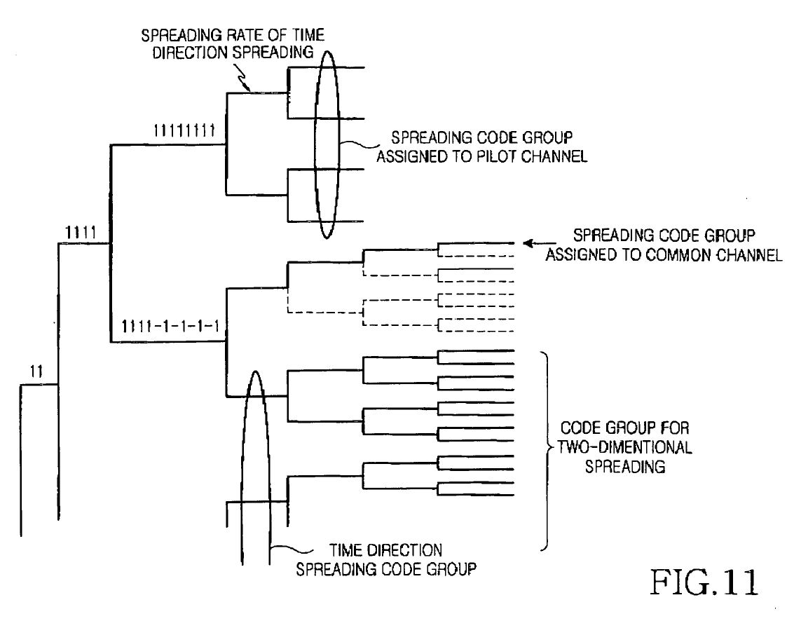

Herein, as illustrated in FIG. 10, a code multiplexing is performed for a individual data channel when a spreading is accomplished. Further, when the code multiplexing is performed, a spreading code branched to a layer of a time direction spreading rate in a spreading code generation tree is assigned to a common channel, such that a reception-side can easily separate the common channel and the individual data channel, as illustrated in FIG. 11.

FIG. 10 is a view illustrating a processing step in the transmitter according to the third embodiment of the present invention and FIG. 11 is a view illustrating a code multiplexing of the common channel and a code multiplexing of the data channel according to the third embodiment of the present invention. Referring to FIG. 10, in multiple nodes having the same spreading rate of a time direction spreading, a spreading code corresponding to a leave generated in each node is assigned to a beam used by the individual data channel. A spreading code generated in the same node is not assigned to a beam used by the common channel. Instead, another spreading code corresponding to a leave generated in a node of a route direction other than the spreading rate of the time direction spreading is assigned to the beam used by the common channel.

Herein, in the same manner as described above, a spreading code branched to the node in the route direction, other than the layer of the time direction spreading rate, is assigned to a pilot channel so that the reception-side can easily separate the common channel and the individual data channel.

In the common channel transmission system according to the third embodiment of the present invention, four row vectors of a space-time coding matrix are spread in four consecutive spreading segments by means of one spreading code.

As described above, in the common channel transmission system according to the third embodiment of the present invention, when the OFDM-CDM scheme is used as a wireless access scheme, a common channel and a data channel are code-multiplexed, thereby easily multiplexing the common channel with the data channel.

Further, in the common channel transmission system according to the third embodiment of the present invention, a code branched to a layer of a time direction spreading rate in a spreading code generation tree is assigned to a common channel. Accordingly, a receiver can perform a space-time coding for each subcarrier.

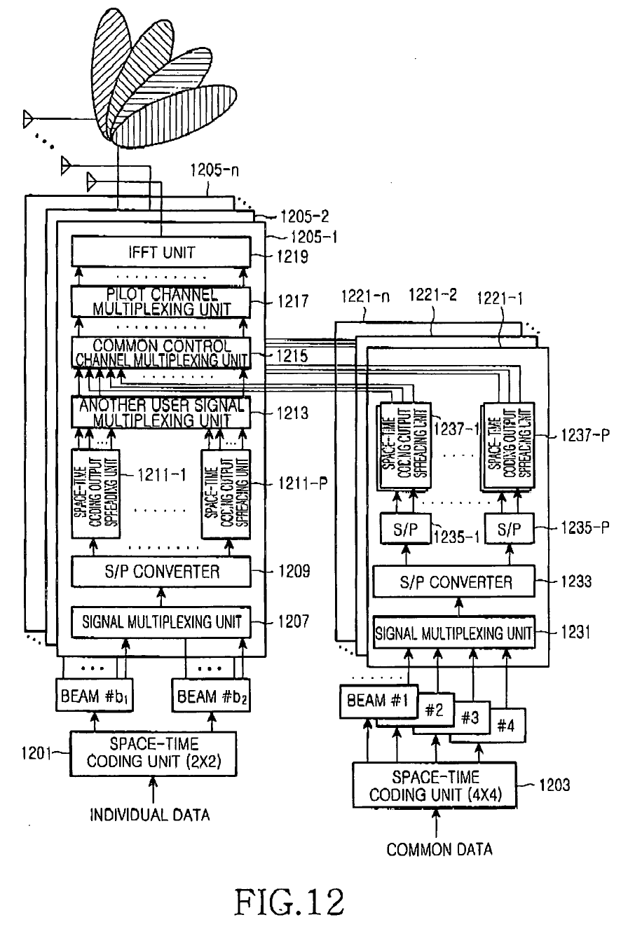

FIG. 12 is a block diagram illustrating a transmitter in the common channel transmission system according to the fourth embodiment of the present invention. The common channel transmission system according to the fourth embodiment of the present invention is different from that of the first embodiment of the present invention in that the common channel transmission system of the fourth embodiment code-multiplexes row vectors of a space-time coding matrix in the same spreading area. More specifically, as illustrated in FIG. 12, among space-time coding output of the space-time coded common data and space-time coding output obtained by space-time coding individual data to be transmitted to multiple users, data transmission units assign the space-time coding output of the space direction to multiple beams of a multibeam, assign the space-time coding output of the time direction to multiple spreading codes in the same spreading area, and then transmit the space-time coding outputs.

Generally, a space-time coding matrix for data channel uses a space-time coding matrix having a matrix size of about 2×2. However, the size of a space-time coding matrix for common channel is determined by an entire beam number as described above. Typically, the beam number is larger than 2×2. Therefore, FIG. 12 illustrates an example of 4×4.

Because each row vector is assigned to a spreading slot in a time direction, when a space-time coding matrix is extended in a row direction, tolerance of a channel for time change is deteriorated. Accordingly, in the common channel transmission system according to the fourth embodiment of the present invention, row vectors of a space-time coding matrix are code-multiplexed in the same spreading area, thereby preventing the tolerance of the channel for time change from being deteriorated.

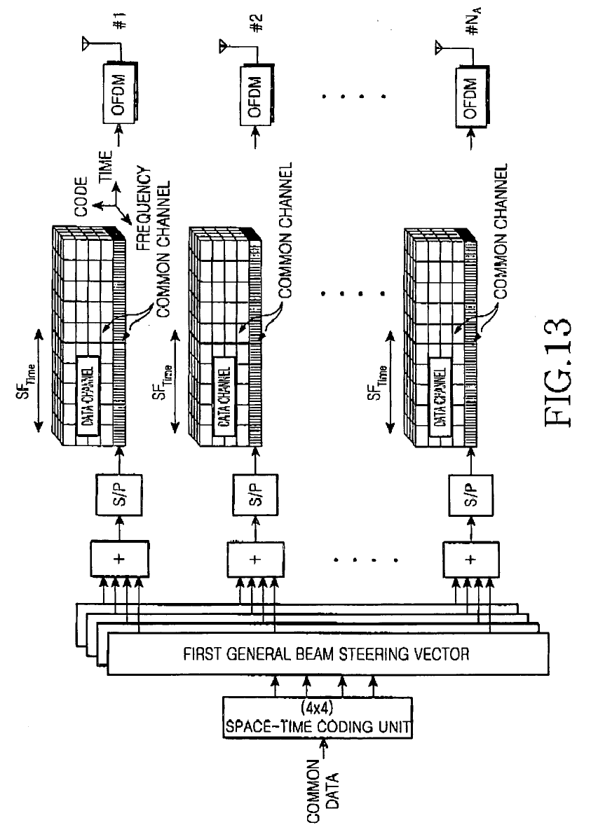

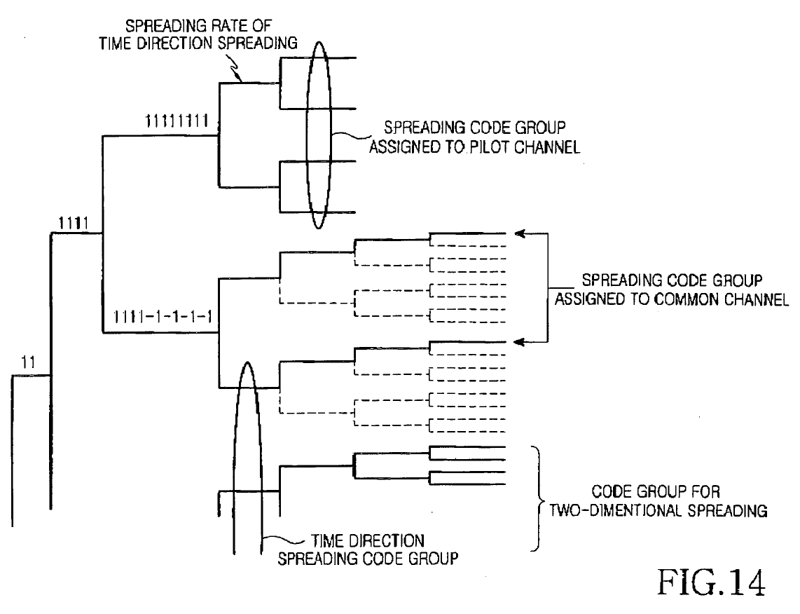

In the present invention, a 4×4 space-time coding matrix for common channel is divided by time intervals equal to those of a 2×2 space-time coding matrix used in a data channel. A more detailed description will be given herein below with reference to FIGS. 13 and 14.

FIG. 13 is a view illustrating a processing step in the transmitter according to the fourth embodiment of the present invention and FIG. 14 is a view illustrating a code multiplexing of the common channel and a code multiplexing of the data channel according to the fourth embodiment of the present invention. Referring to FIG. 13, the 4×4 space-time coding matrix for common channel is divided into two 2×2 space-time coding matrices, which are output in a time direction of the matrix that is serial-to-parallel converted. The converted output is then code-multiplexed with data channel in each spreading area.

FIG. 14 illustrates an operation of each of multiple space-time coding output spreading units 1237-1 to 1237-p disposed after serial-to-parallel converters 1235-1 to 1235-p as illustrated in FIG. 12. That is, in FIG. 14, each of the space-time coding output spreading units 1237-1 to 1237-p assigns another spreading code, i.e., a spreading code branched to a layer of a time direction spreading rate in a spreading code generation tree, to a common channel.

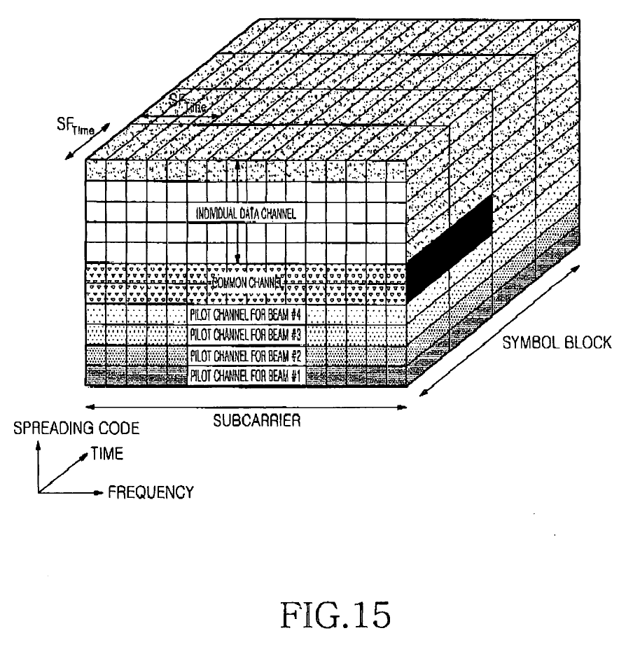

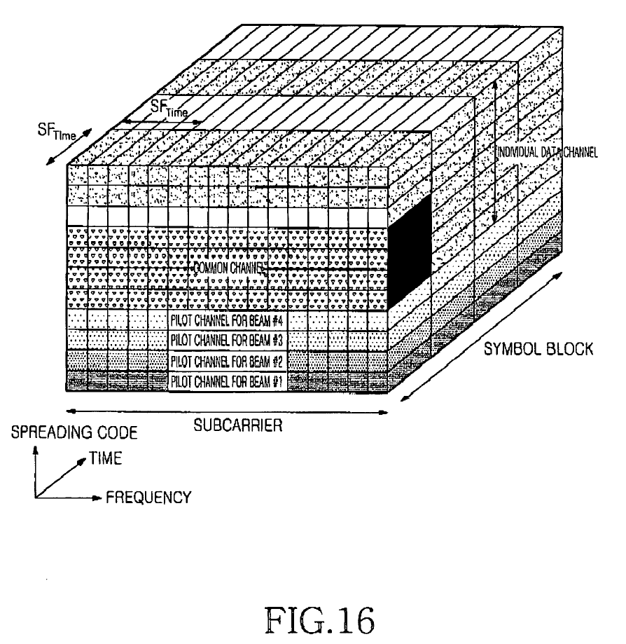

FIG. 15 is a view illustrating a frame obtained by 2 code multiplexing for space-time coding output according to the fourth embodiment of the present invention and FIG. 16 is a view illustrating a frame obtained by 4 code multiplexing for space-time coding output according to the fourth embodiment of the present invention. Referring to FIGS. 15 and 16, as the degree of a code multiplexing increases, a signal spreading in a time direction is reduced. Therefore, tolerance of a channel for time change is improved. That is, in order for the tolerance for time change as described above, the 4×4 space-time coding matrix is decomposed into four 1×4 vectors. The vectors are multiplexed in four spreading codes to the same spreading area. Herein, a 4 multiplexing will be described as an example.

First, the 4×4 space-time coding matrix Ω is divided into four vectors, thereby obtaining the following Equation 16.

$$\begin{matrix}Ω = [ \begin{matrix}{S}_{1} & {S}_{2} & {S}_{3} & {S}_{4} \\ - {S}_{2}^{*} & {S}_{1}^{*} & - {S}_{4}^{*} & {S}_{3}^{*} \\ {S}_{3} & {S}_{4} & {S}_{1} & {S}_{2} \\ - {S}_{4}^{*} & {S}_{3}^{*} & - {S}_{2}^{*} & {S}_{1}^{*}\end{matrix} ] \\ = [ \begin{matrix}{Ω}_{1} \\ {Ω}_{2} \\ {Ω}_{3} \\ {Ω}_{4}\end{matrix} ]\end{matrix} \qquad Equation 16$$

When a beam multiplexing is performed while a beam steering vector Wᵢ (i=1,2,3,4) is weighted to each elements corresponding to each space-time coding matrix Ω₁, Ω₂, Ω₃, and Ω₄, the following Equation 17 is obtained.

$${U}_{i} = {Ω}_{i} [ \begin{matrix}{W}_{1}^{T} \\ {W}_{2}^{T} \\ {W}_{3}^{T} \\ {W}_{4}^{T}\end{matrix} ] \qquad Equation 17$$

Next, signal vectors of Equation 17 are multiplexed by a spreading code cᵢ(n) to the same spreading area. Herein, i represents a number of the spreading code and the n (1,2, . . . , SF) represents a chip number.

The multiplexed signal may be defined as the following Equation 18 and a transmitter transmits a transmission signal V(n).

$$V ( n ) = {\sum }_{i = 1}^{4} {c}_{i} ( n ) {U}_{i} \qquad Equation 18$$

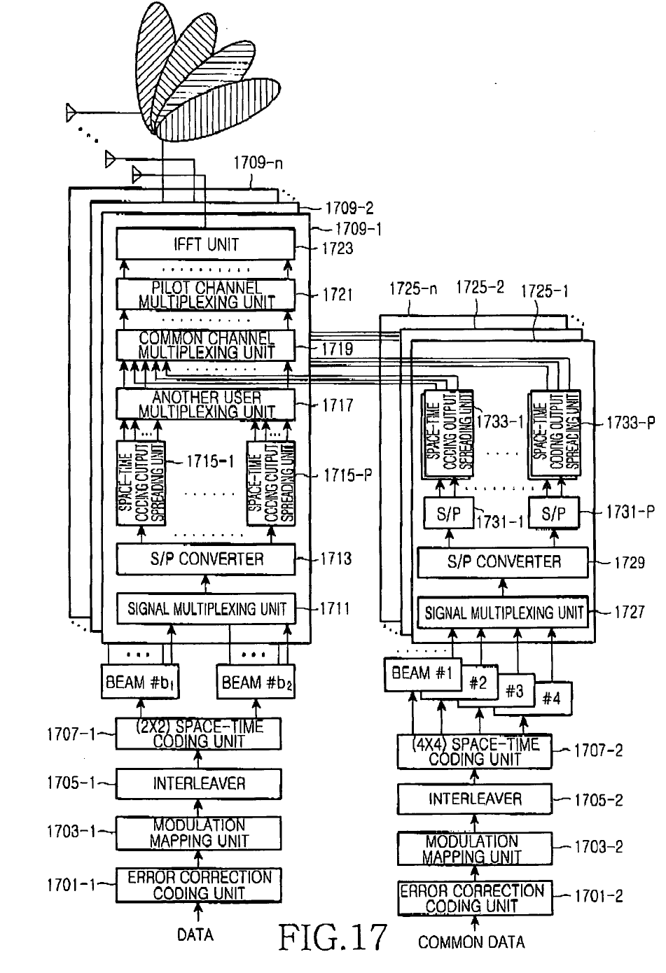

FIG. 17 is a block diagram illustrating a more detailed construction of the transmitter according to the fourth embodiment of the present invention. In comparison with the transmitter of the first embodiment illustrated in FIG. 4, the transmitter according to the fourth embodiment of the present invention has a construction after a serial-to-parallel converter 1729 of a data transmission unit 1725-1 to 1725-n, which is different from that of the transmitter of the first embodiment. Hereinafter, elements equal to those of FIG. 4 will not be described and only elements different from those of FIG. 4 will be described.

As illustrated in FIG. 17, the serial-to-parallel converter 1729 inputs a beam space-time coding transmission symbol multiplexed for multiple beams, perform serial-to-parallel conversion for the input beam space-time coding transmission symbol every four symbols, and output the serial-to-parallel converted symbol to serial-to-parallel converters 1731-1 to 1731-p next to the serial-to-parallel converter 1729. The serial-to-parallel converters 1731-1 to 1731-p each divide a 4×4 space-time coding matrix for common channel into two 2×2 space-time coding matrices, serial-to-parallel convert outputs in a time direction of the matrix, and output the serial-to-parallel converted transmission symbols to space-time coding output spreading units 1733-1 to 1733-p.

The space-time coding output spreading units 1733-1 to 1733-p each receive the serial-to-parallel converted beam space-time coding transmission symbols, and assign the received serial-to-parallel converted beam space-time coding transmission symbols to spreading segments. Further, the space-time coding output spreading units 1733-1 to 1733-p perform a two-dimensional spreading of a time direction and a frequency direction for the transmission symbols in each spreading segment by means of a Walsh code, and then output the two-dimensional spread transmission symbols to common channel multiplexing unit 1719.

The common channel multiplexing unit 1719 performs a multiplexing for multiplexed spreading data (individual data) of another user, which are input from another user multiplexing unit 1717, and spreads data (common data) input from the space-time coding output spreading units 1733-1 to 1733-p in the same spreading area, and then outputs the multiplexed data to a pilot channel multiplexing unit 1721.

The pilot channel multiplexing unit 1721 spreads a pilot signal for each beam to a time direction, multiplexes the spread pilot signal with multiplexed spreading data of said another user again, and outputs the multiplexed signal to the IFFT unit 1723.

The IFFT unit 1723 converts the multiplexed signal to a time domain signal using an IFFT. Further, the IFFT unit 1723 up-converts the time domain signal to a carrier frequency by adding a guard interval (GI) to the time domain signal, and outputs a transmission signal to a transmission array antenna.

The transmission array antenna radiates multiple transmission signals V(n) received from IFFT units 1723 of the data transmission units 1709-1 to 1709-n.

As described above, the common channel transmission system according to the embodiments of the present invention performs a code-multiplexing for row vectors of a space-time coding matrix in the same spreading area. Generally, because a space-time coding matrix for common channel uses a matrix size corresponding to an entire beam number, tolerance of a channel for time change is insufficient when a service is provided to uses moving at a ultra high speed. However, when the embodiments of the present invention are used, spreading slots, which are objects of time change, can be shortened by ½ or ¼. Accordingly, the present invention improves tolerance of a channel for time change.

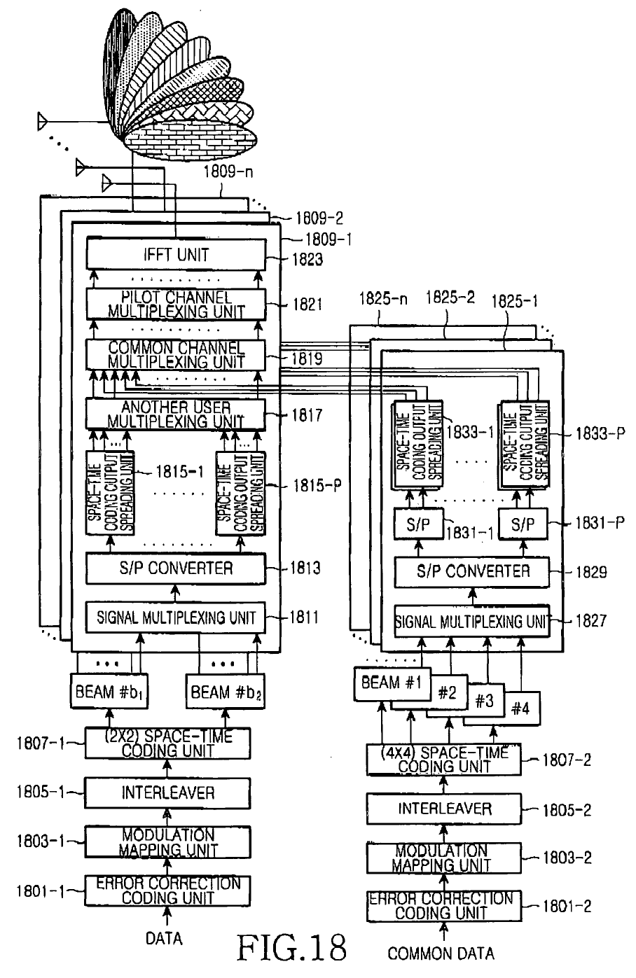

Although preferred embodiments of the present invention have been described above, the scope of the present invention is not limited to only the common channel transmission system having a construction described in each embodiment. For example, as illustrated in FIG. 18, the present invention can include a common channel transmission system having all constructions described in the first to the fourth embodiment. Further, the present invention can also include design change capable of being analogized by those who skilled in the art.

The transmitter and the receiver in the common channel transmission system according to the present invention can include a computer system therein. Further, a series of processing steps regarding the aforementioned common channel transmission processing can be stored in a recording medium capable of being be read by the computer system in the form of a program. Preferably, the computer system reads and executes the program, so that the series of processing steps can be performed. That is, a central processing unit such as a CPU reads the program from a main memory device such as a ROM, RAM, etc., and performs proper processing of the information. Accordingly, processing means and processing units in a transmitter and a receiver of the aforementioned present invention can be achieved.

Herein, the recording medium capable of being be read by the computer system includes a disk, a magneto-optical disk, a CD-ROM, a DVD-ROM, a semiconductor memory, etc. Further, the computer program is connected to a computer system through a communication line and is remote-controlled by the computer system, such that the computer system can automatically execute the corresponding program through the remote control.

As described above, according to the present invention, common data is space-time coded in beams included in a multibeam, the corresponding space-time coded common data is assigned to the beams included in the multibeam and transmitted to multiple users, thereby transmitting the common data to the multiple users by means of the multibeam without losing a beam diversity gain.

Further, according to the present invention, when a beam number of a multibeam assigning the space-time coded common data is extended, column vectors of a space-time coding matrix are cyclically-extended, the space-time coding matrix is extended to be a space-time coding matrix having column vectors of the number equal to the beam number, and common data is space-time coded in the beams by means of the corresponding extended space-time coding matrix and are then transmitted. Accordingly, orthogonality between codes can be maintained and the beam number of the multibeam assigning the common data can be extended.

Further, according to the present invention, the space-time coded common data and individual data to be transmitted to multiple users are space-time coded, space-time coding output of the common data and space-time coding output of the individual data are spread in a time direction and a frequency direction, and the space-time coding output of the common data is assigned to all beams included in a multibeam and transmitted to the multiple users. Simultaneously, the space-time coding output of the individual data is assigned to a beam space of the multibeam and transmitted. Accordingly, the common data can be multiplexed with the individual data.

Furthermore, according to the present invention, among space-time coding output of the space-time coded common data and space-time coding output obtained by space-time coding individual data to be transmitted to multiple users, the space-time coding output of a space direction is assigned to multiple beams of a multibeam. The space-time coding output of a time direction is assigned to multiple spreading codes in the same spreading area, and the space-time coding outputs are then transmitted. Accordingly, spreading slots, which are objects of time change, can be shortened. Therefore, tolerance of a channel for time change can be improved.

While the present invention has been shown and described with reference to certain preferred embodiments thereof, it will be understood by those skilled in the art that various changes in form and details may be made therein without departing from the spirit and scope of the present invention as defined by the appended claims.

1. A common channel transmission system for transmitting common data to multiple users by means of a multibeam, the common channel transmission system comprising:
a common data coding means for space-time coding the common data in beams included in the multibeam; and
a data transmission means for assigning the space-time coded common data to the beams included in the multibeam and transmitting the space-time coded common data to the multiple users.

2. The common channel transmission system as claimed in claim 1, further comprising:
a beam number extending means for cyclically extending column vectors of a space-time coding matrix and extending the space-time coding matrix to be a space-time coding matrix having column vectors of a number equal to a beam number of the multibeam,
wherein the common data coding means space-time codes the common data in the beams using the space-time coding matrix extended by the beam number extending means.

3. The common channel transmission system as claimed in claim 2, wherein the data transmission means further comprises:
an individual data coding means for space-time coding individual data transmitted to the multiple users; and
a space-time coding output spreading means for spreading space-time coding output of the common data and space-time coding output of the individual data in a time direction and a frequency direction.

4. The common channel transmission system as claimed in claim 3, wherein the data transmission means assign the space-time coding output of the common data to the beams included in the multibeam to transmit the space-time coding output to the multiple users, and assigns the space-time coding output of the individual data to a beam space of the multibeam to transmit the space-time coding output to the multiple users.

5. The common channel transmission system as claimed in claim 4, wherein, among the space-time coding output of the space-time coded common data and the space-time coding output obtained by space-time coding individual data to be transmitted to the multiple users, the data transmission means assign the space-time coding output of a space direction to multiple beams of the multibeam, assign the space-time coding output of a time direction to multiple spreading codes in a same spreading area, and transmits the space-time coding outputs.

6. A common channel transmission method for transmitting common data to multiple users by means of a multibeam, the method comprising the steps of:
space-time coding the common data in beams included in the multibeam;
assigning the space-time coded common data to the beams included in the multibeam; and
transmitting the space-time coded common data to the multiple users.

7. The common channel transmission method as claimed in claim 6, further comprising the steps of:
cyclically extending column vectors of a space-time coding matrix and extending the space-time coding matrix to be a space-time coding matrix having column vectors of a number equal to a beam number of the multibeam, when the beam number of the multibeam assigning the space-time coded common data is extended;
performing a space-time coding for the common data in the beams using the extended space-time coding matrix; and
transmitting the coded common data.

8. The common channel transmission method as claimed in claim 7, further comprising the steps of:
space-time coding the space-time coded common data and individual data to be transmitted to the multiple users;
spreading space-time coding output of the common data and space-time coding output of the individual data in a time direction and a frequency direction;
assigning the space-time coding output of the common data to all beams included in the multibeam to transmit the space-time coding output to the multiple users; and
simultaneously assigning the space-time coding output of the individual data to a beam space of the multibeam to transmit the space-time coding output to the multiple users.

9. The common channel transmission method as claimed in claim 8, wherein, among the space-time coding output of the space-time coded common data and the space-time coding output obtained by space-time coding individual data to be transmitted to the multiple users, the space-time coding output of a space direction is assigned to multiple beams of the multibeam, the space-time coding output of a time direction is assigned to multiple spreading codes in a same spreading area, and the space-time coding outputs are transmitted.

10. A recording medium for storing a program for performing by computer a series of processing steps to transmit common data to multiple users by means of a multibeam, the recording medium comprising:
a processing means for space-time coding the common data in beams included in the multibeam; and
a program module including a program for assigning the space-time coded common data to the beams included in the multibeam.

11. The recording medium as claimed in claim 10, wherein, when the beam number of the multibeam assigning the space-time coded common data is extended, column vectors of a space-time coding matrix are cyclically extended such that the space-time coding matrix is extended to be a space-time coding matrix having column vectors of a number equal to the beam number, and a space-time coding is performed for the common data in the beams by means of the extended space-time coding matrix.

12. The recording medium as claimed in claim 11, wherein the space-time coded common data and individual data to be transmitted to the multiple users are space-time coded, space-time coding output of the common data and space-time coding output of the individual data are spread in a time direction and a frequency direction, the space-time coding output of the common data is assigned to the beams included in the multibeam, and the space-time coding output of the individual data to a beam space of the multibeam is assigned.

13. The recording medium as claimed in claim 12, wherein, among the space-time coding output of the space-time coded common data and the space-time coding output obtained by space-time coding individual data to be transmitted to the multiple users, the space-time coding output of a space direction is assigned to multiple beams of the multibeam, and the space-time coding output of a time direction is assigned to multiple spreading codes in a same spreading area.
